(19) United States
(12) Patent Application Publication
(10) Pub. No.: US 2025/0014061 A1
(43) Pub. Date: Jan. 9, 2025

(54) INFORMATION PROCESSING DEVICE

(71) Applicant: TOYOTA JIDOSHA KABUSHIKI KAISHA, Toyota-shi (JP)

(72) Inventors: Hideyuki TAKAKI, Okazaki-shi (JP); Yusuke Tsumita, Kashiwa-shi (JP); Satoshi Kajiyama, Osaka (JP); Yasuhiro Kobatake, Nagoya-shi (JP); Takafumi Yamadaira, Nagoya-shi (JP); Kumiko Hayashi, Nagoya-shi (JP); Tomoya Kajikawa, Nagoya-shi (JP)

(73) Assignee: TOYOTA JIDOSHA KABUSHIKI KAISHA, Toyota-shi (JP)

(21) Appl. No.: 18/891,618

(22) Filed: Sep. 20, 2024

(30) Foreign Application Priority Data
Feb. 7, 2023 (JP) 2023-207232

(51) Int. Cl. G06Q 30/0207; G06Q 10/0833

(52) U.S. Cl. CPC G06Q 30/0207; G06Q 10/0833

(57) ABSTRACT

An information processing device includes a control unit. The control unit gives an incentive to the purchaser every time the purchaser of the vehicle logs in to the service that provides the information of the vehicle at predetermined time intervals during a target period from when the vehicle is ordered until when the vehicle is delivered.

### CROSS-REFERENCE TO RELATED APPLICATION

This application claims priority to Japanese Patent Application No. 2023-207232 filed on Dec. 7, 2023, incorporated herein by reference in its entirety.

### BACKGROUND

### 1. Technical Field

The present disclosure relates to an information processing device.

### 2. Description of Related Art

Conventionally, a technique of providing a user with a progress status of a specific vehicle until delivery is known (Japanese Unexamined Patent Application Publication No. 2002-297954).

### SUMMARY

The conventional technique has room for improvement in terms of enhancing the expectation of a user for the delivery.

An object of the present disclosure made in view of this point is to enhance the expectation of the user for the delivery.

An information processing device according to an embodiment of the present disclosure includes a control unit that gives an incentive to a purchaser of a vehicle every time the purchaser logs in a service that provides information on the vehicle at predetermined time intervals during a target period from order of the vehicle to delivery of the vehicle.

An embodiment of the present disclosure can enhance the expectation of a user for the delivery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating a schematic configuration of a system according to an embodiment of the present disclosure; and

FIG. 2 is a sequence diagram illustrating an example of a processing procedure of the system illustrated in FIG. 1.

### DETAILED DESCRIPTION OF EMBODIMENTS

Hereinafter, an embodiment of the present disclosure will be described below with reference to the drawings.

### System Configuration

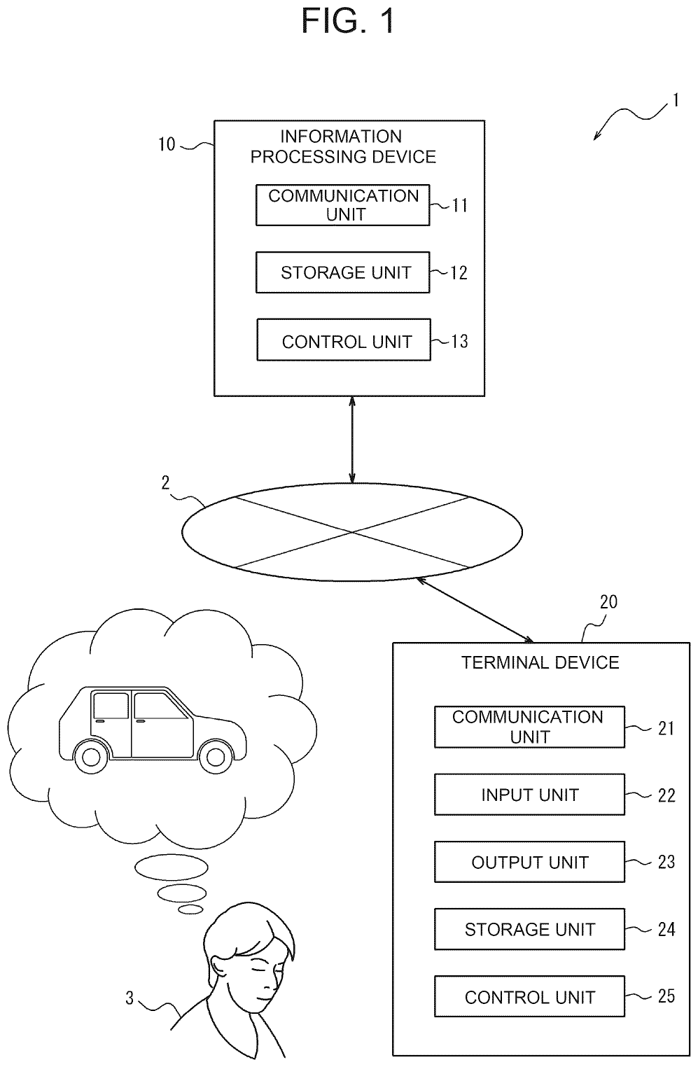

As illustrated in FIG. 1, the system 1 according to the present embodiment includes an information processing device 10 and a terminal device 20. The system 1 may include a plurality of terminal devices 20.

The information processing device 10 and the terminal device 20 can communicate with each other via a network 2. The network 2 may be any network including a mobile communication network, the Internet, and the like.

The information processing device 10 is managed by, for example, a dealer of a vehicle. The information processing device 10 provides a service for providing vehicle information to the purchaser 3 of the vehicle. In the present embodiment, it is assumed that the service for providing the information of the vehicle is a website where the information of the vehicle can be browsed. However, the service for providing the information of the vehicle is not limited to the website. The information of the vehicle that can be browsed at the website is, for example, a captured image of the vehicle being assembled and position information of the vehicle being transported.

The information processing device 10 is a dedicated computer configured to function as a server, a general-purpose personal computer, a cloud computing system, or the like.

The information processing device 10 includes a communication unit 11, a storage unit 12, and a control unit 13.

The communication unit 11 is configured to include at least one communication module that can be connected to the network 2. The communication module is, for example, a communication module compatible with a standard such as a wired local area network (LAN) or a wireless LAN. The communication unit 11 is connected to the network 2 with the communication module via a wired LAN or a wireless LAN.

The storage unit 12 is configured to include at least one semiconductor memory, at least one magnetic memory, at least one optical memory, or a combination of at least two of them. The semiconductor memory is, for example, a random access memory (RAM), a read only memory (ROM), or the like. The RAM is, for example, a static random access memory (SRAM), a dynamic random access memory (DRAM), or the like. ROM is, for example, an electrically erasable programmable read only memory (EEPROM). The storage unit 12 may function as a main storage device, an auxiliary storage device, or a cache memory. The storage unit 12 stores data used for the operation of the information processing device 10 and data acquired through the operation of the information processing device 10. For example, the storage unit 12 stores login information of the purchaser 3. The login information includes a login ID and a password of the purchaser 3.

The control unit 13 is configured to include at least one processor, at least one dedicated circuit, or a combination thereof. The processor is, for example, a general-purpose processor such as a central processing unit (CPU) or a graphics processing unit (GPU), or a dedicated processor specialized for a specific process. The dedicated circuit is, for example, a field-programmable gate array (FPGA) or an application-specific integrated circuit (ASIC). The control unit 13 executes processes related to the operation of the information processing device 10 while controlling various units of the information processing device 10.

The terminal device 20 is used by the purchaser 3. The purchaser 3 uses the terminal device 20 to access a website provided by the information processing device 10. The purchaser 3 can view the information of the vehicle from the website. An application program for accessing a website provided by the information processing device 10 may be installed in the terminal device 20.

The terminal device 20 is, for example, a smart phone, a tablet terminal, a laptop personal computer (PC), a desktop PC, or the like.

The terminal device 20 includes a communication unit 21, an input unit 22, an output unit 23, a storage unit 24, and a control unit 25.

The communication unit 21 is configured to include at least one communication module that can be connected to the network 2. The communication module is, for example, a communication module compliant with a standard such as a wired local area network (LAN) or a wireless LAN. Alternatively, the communication module is a communication module compatible with a mobile communication standard such as long term evolution (LTE), 4th generation (4G), or 5th generation (5G).

The input unit 22 can accept an input from the user. The input unit 22 is configured to include at least one input interface capable of accepting an input from the user. The input interface is, for example, a physical key, a capacitive key, a pointing device, a touch screen or a microphone integrally provided with the display of the output unit 23, or the like.

The output unit 23 can output data. The output unit 23 is configured to include at least one output interface capable of outputting data. The output interface is, for example, a display or a speaker. The display may be, for example, a liquid crystal display (LCD), an organic electroluminescence (EL) display, or the like.

The storage unit 24 is configured to include at least one semiconductor memory, at least one magnetic memory, at least one optical memory, or a combination of at least two of them. The storage unit 24 may function as a main storage device, an auxiliary storage device, or a cache memory. The storage unit 24 stores data used for the operation of the terminal device 20 and data acquired through the operation of the terminal device 20.

The control unit 25 is configured to include at least one processor, at least one dedicated circuit, or a combination thereof. The configuration of the control unit 25 may be the same as or similar to that of the control unit 13. The control unit 25 performs processes related to the operation of the terminal device 20 while controlling each unit of the terminal device 20.

### System Operation

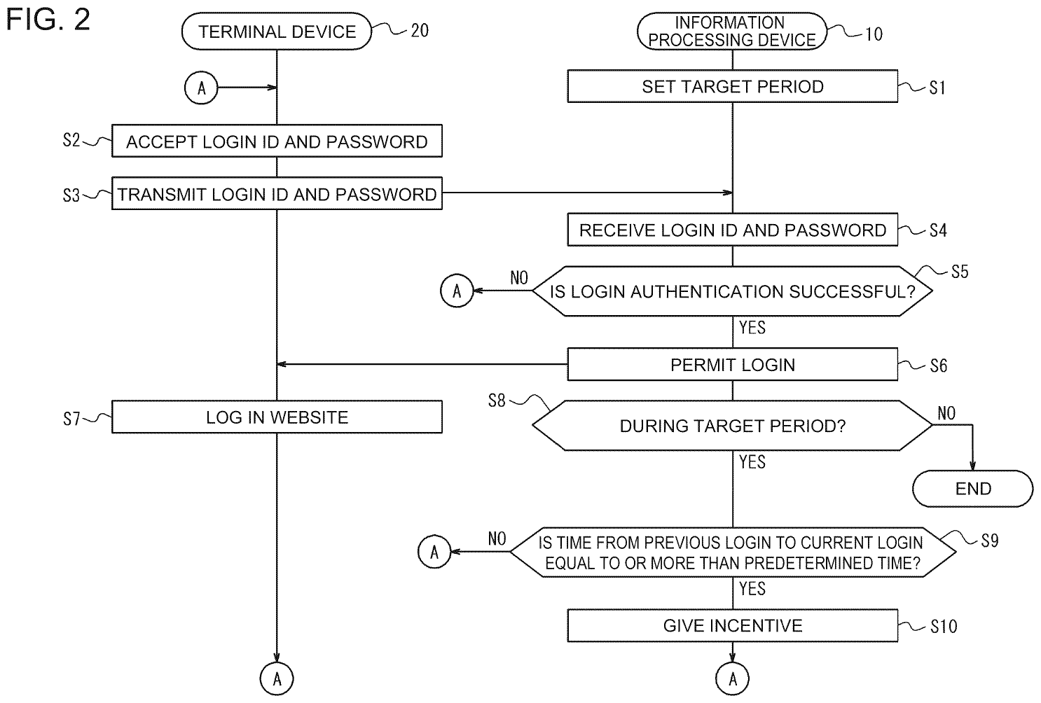

FIG. 2 is a sequence diagram illustrating an example of a processing procedure of the system 1 illustrated in FIG. 1. For example, when the purchaser 3 orders the vehicles, the system 1 starts S1 process.

In S1 process, the control unit 13 of the information processing device 10 sets a target period. The target period is a period in which an incentive is given to the purchaser 3 each time the purchaser 3 logs in to a service that provides vehicle information at predetermined time intervals. As described above, the service providing the information of the vehicle is a website in which the information of the vehicle can be browsed. The predetermined time may be set based on the update frequency of the information of the vehicle posted on the website. The predetermined time period is, for example, one day to several days. The control unit 13 sets a period from when the purchaser 3 orders a vehicle until when the vehicle is delivered as a target period.

In S2 process, the control unit 25 of the terminal device 20 receives the log-in ID and the password from the purchaser 3 by the input unit 22. When the purchaser 3 wants to browse the website, he/she inputs the log-in ID and the password from the input unit 22.

In S3 process, the control unit 25 of the terminal device 20 transmits the log-in ID and the password received in S2 process to the information processing device 10 via the network 2 by the communication unit 21.

In S4 process, the control unit 13 of the information processing device 10 receives the log-in ID and the password from the terminal device 20 via the network 2 by the communication unit 11.

In S5 process, the control unit 13 executes login authentication based on the login ID and password of the purchaser 3 received in S4 process and the login information of the purchaser 3 in the storage unit 12. When the login-authentication is successful (S5: YES), the control unit 13 proceeds to S6 process. On the other hand, if the control unit 13 fails to log-in authentication (S5: NO), the system 1 returns to the process of S2.

In S6 process, the control unit 13 of the information processing device 10 permits the terminal device 20 to log in to the website. The control unit 13 transmits the data of the web page to the terminal device 20 via the network 2 by the communication unit 11.

In S7 process, the control unit 25 of the terminal device 20 logs in the website. Further, the control unit 25 receives the data of the web page from the information processing device 10 via the network 2 by the communication unit 21. The control unit 25 displays the received web page on the display of the output unit 23. The purchaser 3 can view the information of the vehicle by looking at the well page.

In S8 process, the control unit 13 determines whether or not the timing at which the terminal device 20 logs in is within the target period in S7 process. When the control unit 13 determines that the timing at which the terminal device 20 logs in is within the target period (S8: YES), the process proceeds to S9 process. On the other hand, when the control unit 13 determines that the timing at which the terminal device 20 logs in is not within the target period (S8: NO), the system 1 ends the process illustrated in FIG. 2.

In S9 process, the control unit 13 determines whether or not the time from when the terminal device 20 logs in last time to when the terminal device 20 logs in this time is equal to or longer than a predetermined time in S7 process. When the control unit 13 determines that the time from when the terminal device 20 logs in last time to when the terminal device 20 logs in this time in S7 process is equal to or longer than the predetermined time (S9: YES), the process proceeds to S10 process. On the other hand, when the control unit 13 determines that the time from when the terminal device 20 logs in last time to when the terminal device 20 logs in this time is not equal to or longer than the predetermined time in S7 process (S9: NO), the system I returns to the process of S2.

In S10 process, the control unit 13 provides an incentive to the purchaser 3. The incentives may include, for example, coupons available at the dealer of the vehicle. The coupon may be a discount coupon available at the dealer or may be a coupon interchangeable with goods.

After performing S10 process, the system 1 returns to S2 process. With such a configuration, an incentive is given to the purchaser 3 every time the purchaser 3 logs in the website at predetermined time intervals in the target period.

As described above, in the present embodiment, in the target period, an incentive is given to the purchaser 3 every time the purchaser 3 logs in to the service that provides the information of the vehicle every predetermined time, that is, in the present embodiment, the website. Here, only providing the information of the vehicle to the purchaser 3 may not maintain the expectation of the delivery of the vehicle by the purchaser 3 until the vehicle is delivered. In the present embodiment, an incentive is given to the purchaser 3 every time the purchaser 3 logs in to the service at predetermined time intervals in the target period. With such a configuration, it is possible to motivate the purchaser 3 to repeatedly log in to the service. Further, by giving the purchaser 3 motivation to log in to the service, it is possible to maintain the expectation of the purchaser 3 for the delivery of the vehicle until the vehicle is delivered. Therefore, according to the present embodiment, it is possible to enhance the purchaser 3′s expectation of the delivery.

Here, in S8 process, the control unit 13 of the information processing device 10 may extend the target period when the delivery date of the vehicles is later than a preset delivery date. The preset delivery date is, for example, the delivery date set when the order of the vehicle is confirmed. The control unit 13 may extend the target period by including the extended period in the target period. If the target period is extended, in S8 process, the control unit 13, the timing of the terminal device 20 is logged in S7 process, it may be determined whether within the target period after the extension. When the delivery date of the vehicle is later than the preset delivery date, the target period is extended, whereby an opportunity to give an incentive to the purchaser 3 can be increased. By increasing the opportunity to give an incentive to the purchaser 3, even when the delivery of the vehicle is delayed, it is possible to maintain the expectation of the purchaser 3 for the delivery.

Further, when the target period is extended in S8 process, the control unit 13 may give an incentive higher than a preset incentive. That is, when the purchaser 3 logs in the service in the extended period extended in the target period, the control unit 13 may give an incentive higher than an incentive set in advance in S10 process. The preset incentive is, for example, an incentive given when the purchaser 3 logs in to the service during the normal target period. If the incentive is a discount coupon available at the dealer, the control unit 13 may increase the incentive by, for example, increasing the discount rate of the coupon. A normal target period is a target period that does not include an extended period. The normal target period may be a target period set when an order of the vehicle is confirmed. By giving a high incentive to the purchaser 3 when the purchaser 3 logs in to the service in the extended period, it is possible to reduce the possibility that the purchaser 3 feels dissatisfaction even when the delivery of the vehicle is delayed. The control unit 13 may give an incentive higher than a preset incentive every time the purchaser 3 logs in to the service at predetermined time intervals in the extended period.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, when the login authentication using the login ID and the password is successful, the terminal device 20 logs in to the service that provides the information of the vehicle. However, the login authentication using the login ID and the password may not be executed in the login to the service. For example, an application program that automatically logs in to the service may be installed in the terminal device 20. In this case, when the application program of the terminal device 20 is activated, the terminal device 20 may automatically log in to the service. In the terminal device 20, the control unit 25 may activate the application program based on the input of the purchaser 3 received by the input unit 22.

What is claimed is:

1. An information processing device comprising a control unit that gives an incentive to a purchaser of a vehicle every time the purchaser logs in a service that provides information on the vehicle at predetermined time intervals during a target period from order of the vehicle to delivery of the vehicle.

2. The information processing device according to claim 1, wherein the control unit extends the target period when a delivery date of the vehicle becomes later than a preset delivery date.

3. The information processing device according to claim 2, wherein when the purchaser logs in the service during an extended period extended in the target period, the control unit gives an incentive higher than a preset incentive.

4. The information processing device according to claim 3, wherein the preset incentive is an incentive given when the purchaser logs in the service during the target period that is normal.

5. The information processing device according to claim 1, wherein the incentive includes a coupon usable at a dealer of the vehicle.
